(19) United States
(12) Patent Application Publication
(10) Pub. No.: US 2020/0173207 A1
(43) Pub. Date: Jun. 4, 2020

(54) OUTER HANDLE DEVICE FOR VEHICLE DOOR

(71) Applicant: KABUSHIKI KAISHA HONDA LOCK, MIYAZAKI-SHI, MIYAZAKI (JP)

(72) Inventor: Norio SHIMIZU, MIYAZAKI-SHI, MIYAZAKI (JP)

(21) Appl. No.: 16/623,134

(22) PCT Filed: Jun. 11, 2018
(86) PCT No.: PCT/JP2018/022228

§ 371 Date: Dec. 16, 2019

(30) Foreign Application Priority Data
Jun. 20, 2017 (JP) 2017-120375

(51) Int. Cl. E05B 85/14; E05B 79/06

(52) U.S. Cl. CPC E05B 85/14; E05B 79/06

(57) ABSTRACT

An outer handle device for a vehicle door has a decorative cover mounted on an outer face of a handle body that forms part of an outer handle and is disposed on an outer panel, wherein a mounting groove having a substantially U-shaped cross section and formed from a bottom wall and a pair of side walls connected to the bottom wall is formed in an outside face of the handle body, and a plurality of supporting projections, which abut against the decorative cover inserted into the mounting groove and form a first gap between the bottom wall and the decorative cover, are provided on the bottom wall while being disposed on a periphery of a plurality of injection holes provided in the bottom wall for injecting an adhesive so as to fill the first gap, with one of the supporting projections corresponding to one of the injection holes.

### TECHNICAL FIELD

The present invention relates to an outer handle device for a vehicle door in which a handle base is fixed to an outer panel of a vehicle door, an outer handle having a handle body disposed on an outer side of the outer panel is pivotably supported on the handle base, and a decorative cover is mounted on an outer face on the outer side in a vehicle width direction of the handle body.

### BACKGROUND ART

An outer handle in which a decorative cover for enhancing the design is mounted on an outside face of a handle body disposed on the outer side of an outer panel is already known from Patent Document 1.

### RELATED ART DOCUMENTS

### Patent Documents

Patent Document 1: Japanese Utility Model Registration Application Laid-open No. 55-47437

### DISCLOSURE OF INVENTION

### Problems to be Solved by the Invention

In the arrangement disclosed in Patent Document 1 above, opposite end parts of the decorative cover inserted into a mounting groove formed in the outside face of the handle body are resiliently engaged with the handle body, and since the decorative cover is not fixed to the handle body, when a vehicle user grips and operates the handle body, a slight displacement occurs in a part where the decorative cover is in contact with the handle body, thus causing an abnormal noise. In order to prevent the occurrence of an abnormal noise the decorative cover may be fixed to the handle body, and an outer handle in which a decorative cover is adhered and fixed to a handle body by means of double-sided tape already exists, but the use of double-sided tape will increase the cost. In order to fix a decorative cover to a handle body while suppressing an increase in cost, adhering the decorative cover to the handle body by means of an adhesive can be considered, but in this case there is a desire to reliably fix a part via which the decorative cover is in contact with the handle body while suppressing the amount of adhesive, thus reducing the occurrence of an abnormal noise.

The present invention has been accomplished in light of such circumstances, and it is an object thereof to provide an outer handle device for a vehicle door that can reliably fix a part via which a decorative cover is in contact with a handle body while suppressing the amount of adhesive used and reducing the cost, thus enabling the occurrence of an abnormal noise to be suppressed.

### Means for Solving the Problems

In order to attain the above object, according to a first aspect of the present invention, there is provided an outer handle device for a vehicle door in which a handle base is fixed to an outer panel of a vehicle door, an outer handle having a handle body disposed on an outer side of the outer panel is pivotably supported on the handle base, and a decorative cover is mounted on an outer face on the outer side in a vehicle width direction of the handle body, characterized in that a mounting groove is formed in an outside face of the handle body along the vehicle width direction, the mounting groove having a substantially U-shaped cross section and comprising a bottom wall that follows upward and downward directions in a state in which the outer handle is attached to the vehicle door and a pair of side walls connected to upper and lower ends of the bottom wall, and a plurality of supporting projections, which abut against the decorative cover inserted into the mounting groove and form a first gap between the bottom wall and the decorative cover, are projectingly provided on the bottom wall while being disposed on a periphery of a plurality of injection holes provided in the bottom wall for injecting an adhesive so as to fill the first gap, with at least one of the supporting projections corresponding to one of the injection holes.

Further, according to a second aspect of the present invention, in addition to the first aspect, the mounting groove is formed in the handle body so as to extend lengthwise in a vehicle fore-and-aft direction in a state in which the outer handle is attached to the vehicle door, the injection holes are formed in the bottom wall at a plurality of locations spaced in a longitudinal direction of the mounting groove, and a plurality of positioning projections that abut against the decorative cover so as to form, between the side wall and the decorative cover, a second gap communicating with the first gap are projectingly provided on the pair of side walls so as to be disposed at positions corresponding to the injection holes in the longitudinal direction of the mounting groove.

It should be noted here that a first mounting groove 34 of an embodiment corresponds to the mounting groove of the present invention, a first supporting projection 39 of the embodiment corresponds to the supporting projection of the present invention, and a first positioning projection 59 of the embodiment corresponds to the positioning projection of the present invention.

### Effects of the Invention

In accordance with the first aspect of the present invention, since the decorative cover is fixed to the handle body by the use of an adhesive, compared with a case in which double-sided tape is used, it is possible to fix the decorative cover to the handle body while cutting the cost and improving the workability. The decorative cover is in contact with the supporting projections, and at least one supporting projection is disposed on the periphery of each of the plurality of injection holes provided in the bottom wall of the mounting groove. Since the adhesive that is injected into the first gap via the injection hole reliably fills the area around the supporting projection in the first gap, it becomes possible to reliably fix a part via which the decorative cover is in contact with the handle body, the part being the source of an abnormal noise, that is, a part via which the decorative cover is in contact with the supporting projection, while making it unnecessary to inject the adhesive into the entirety of the first gap and suppressing the amount of adhesive used. The occurrence of an abnormal noise can be suppressed by reliably fixing the part via which the decorative cover is in contact with the handle body while suppressing the amount of adhesive used and reducing the cost.

Furthermore, in accordance with the second aspect of the present invention, since the positioning projections, which are in contact with the decorative cover, are projectingly provided on the pair of side walls of the mounting groove so as to correspond to the injection holes disposed at a plurality of locations spaced in the longitudinal direction of the mounting groove, and the adhesive is made to flow, via the first gap, into the second gap formed between the side wall and the decorative cover, it is possible to reliably fix a part via which the opposite side parts of the decorative cover are in contact with the handle body, that is, a part via which the decorative cover is in contact with the positioning projection while making it unnecessary to inject the adhesive into the entirety of the second gap and thereby suppressing the amount of adhesive used. The occurrence of an abnormal noise can be suppressed by reliably fixing the part via which the decorative cover is in contact with the handle body while suppressing the amount of adhesive used and reducing the cost.

### BRIEF DESCRIPTION OF DRAWINGS

FIG. 1 is a side view showing part of a vehicle door. (first embodiment)

FIG. 2 is a sectional view along line 2-2 in FIG. 1. (first embodiment)

FIG. 3 is an exploded perspective view of an outer handle. (first embodiment)

FIG. 4 is a side view showing a handle cover and a decorative cover in a disassembled state. (first embodiment)

FIG. 5 is a side view of the handle cover in a state in which the decorative cover is mounted when viewed from the inner side in the vehicle width direction. (first embodiment)

FIG. 6 is a perspective view from the direction of arrow 6 in FIG. 4. (first embodiment)

FIG. 7 is a perspective view from the direction of arrow 7 in FIG. 4. (first embodiment)

FIG. 8 is a perspective view from the direction of arrow 8 in FIG. 4. (first embodiment)

FIG. 9 is a perspective view from the direction of arrow 9 in FIG. 4. (first embodiment)

FIG. 10 is a perspective view from the direction of arrow 10 in FIG. 4. (first embodiment)

FIG. 11 is a perspective view from the direction of arrow 11 in FIG. 4. (first embodiment)

FIG. 12 is a sectional view along line 12-12 in FIG. 5. (first embodiment)

FIG. 13 is a sectional view along line 13-13 in FIG. 5. (first embodiment)

FIG. 14 is a sectional view along line 14-14 in FIG. 5. (first embodiment)

FIG. 15 is a sectional view along line 15-15 in FIG. 5. (first embodiment)

FIG. 16 is a perspective view of a base cover. (first embodiment)

FIG. 17 is a side view of the base cover in a state in which a decorative cover for the base cover is mounted when viewed from the inner side in the vehicle width direction. (first embodiment)

FIG. 18 is a sectional view along line 18-18 in FIG. 17. (first embodiment)

### EXPLANATION OF REFERENCE NUMERALS AND SYMBOLS

21 Outer panel
22 Outer handle
24 Handle body
29 Handle base
34 Mounting groove
35 Bottom wall
36, 37 Side wall
38 Decorative cover
39 Supporting projection
44, 45, 46, 47 Injection hole
56 First gap
57 Second gap
58 Adhesive
59 Positioning projection
D Vehicle door

### MODES FOR CARRYING OUT THE INVENTION

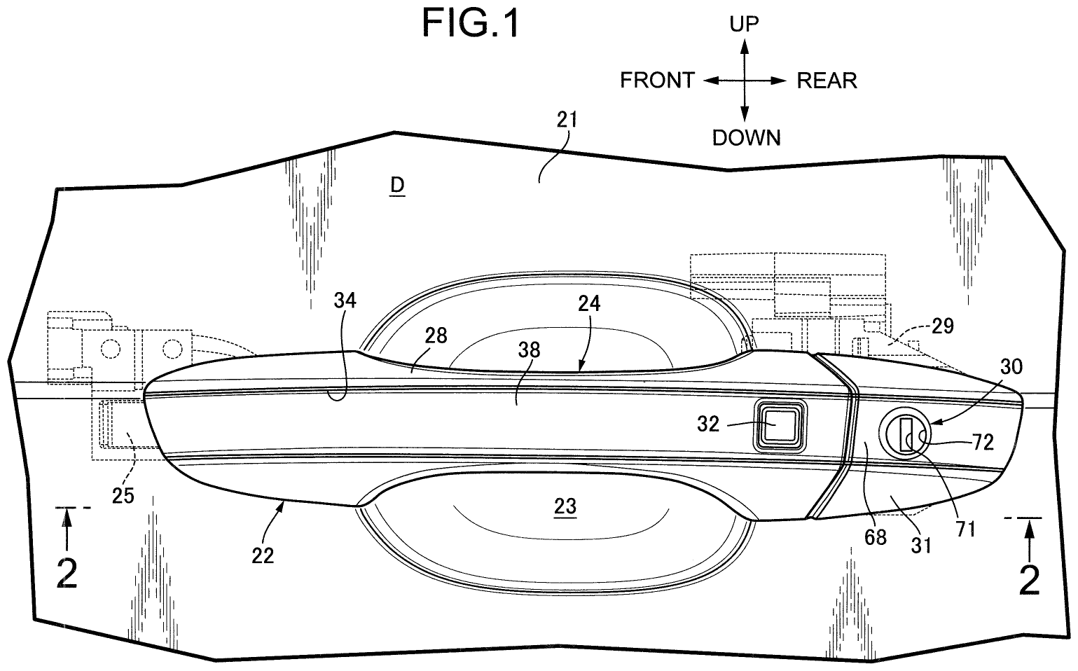

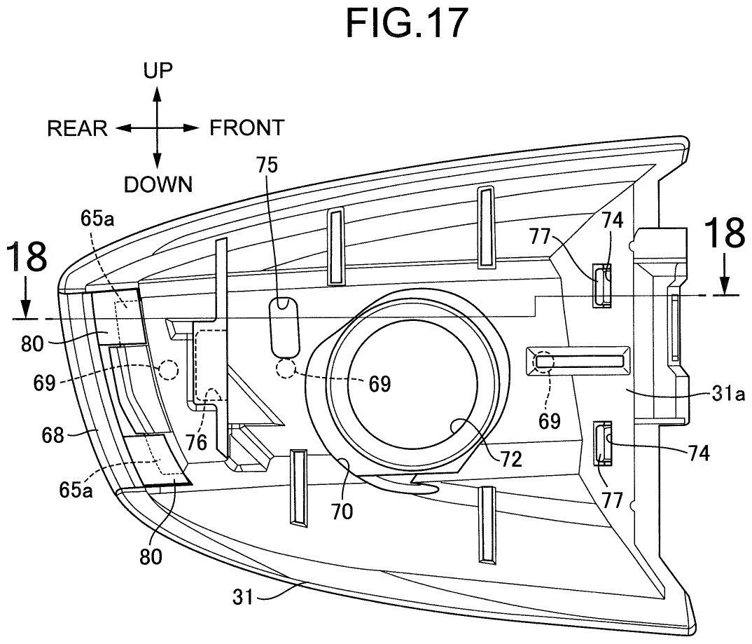

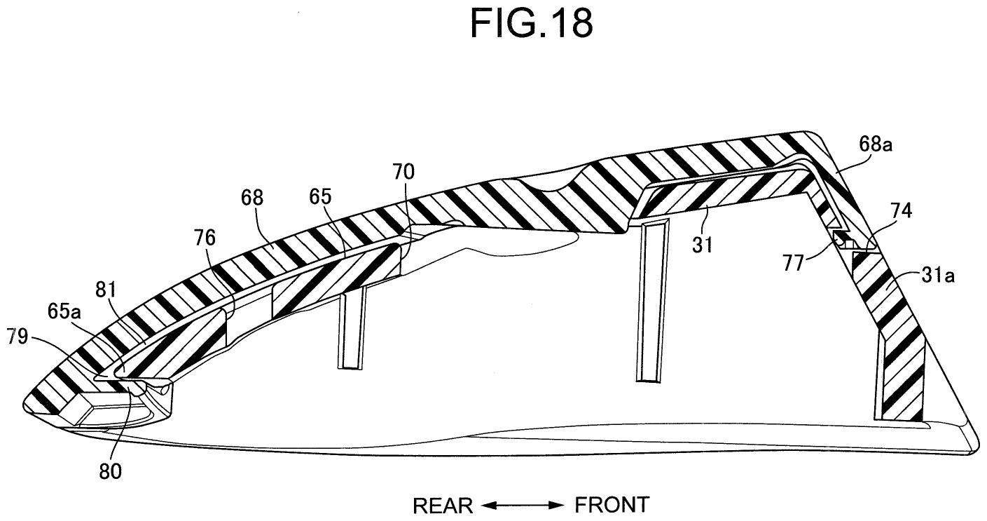

An embodiment of the present invention is explained below by reference to the attached FIG. 1 to FIG. 18.

### First Embodiment

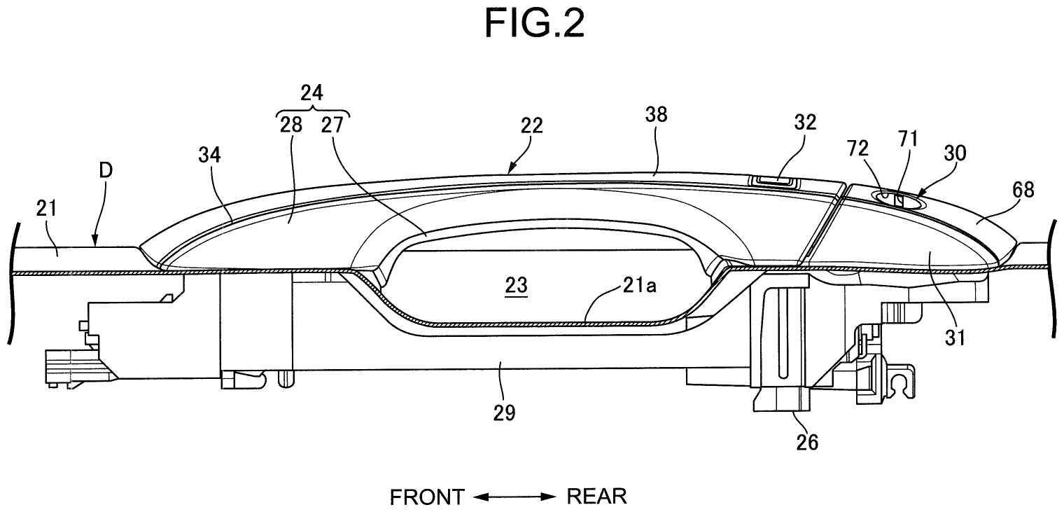

First, in FIG. 1 and FIG. 2, an outer handle 22 is pivotably mounted on an outer panel 21 of a vehicle door D, for example a side door, the outer handle 22 being capable of being operated on an outer face side of the vehicle door D. A curved portion 21a is provided on the outer panel 21 so as to protrude inward in the vehicle width direction, the curved portion 21a forming a depression 23 that enables the hand of a vehicle user holding the outer handle 22 on the outer side of the outer panel 21 to be inserted thereinto.

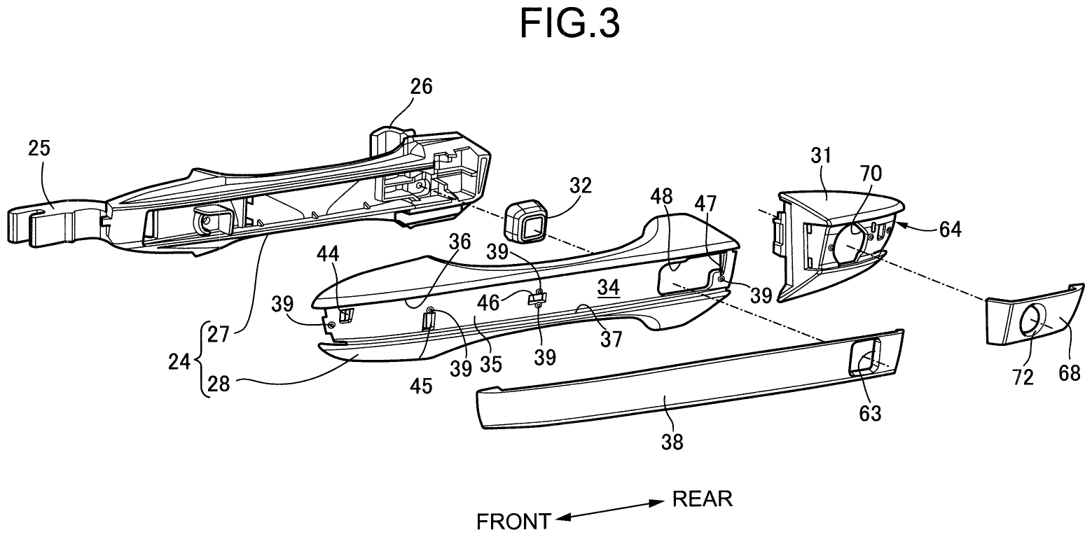

Referring in addition to FIG. 3, the outer handle 22 has a handle body 24 disposed so as to extend in the vehicle fore-and-aft direction on the outer side of the outer panel 21, a substantially L-shaped support arm part 25 connectedly provided on a front end part, in the vehicle fore-and-aft direction, of the handle body 24, and a linking arm part 26 connectedly provided so as to be close to the other end part of the handle body 24.

The handle body 24 is formed from a handle body main part 27, made of a synthetic resin, having a substantially U-shaped cross-sectional shape opening on the side opposite to the outer panel 21, and a handle cover 28, made of a synthetic resin, covering the handle body main part 27 from the side opposite to the outer panel 21; the support arm part 25 is integrally and connectedly provided with a front end part of the handle body main part 27 in the vehicle fore-and-aft direction, and the linking arm part 26 is integrally and connectedly provided with a rear end part of the handle body main part 27 in the vehicle fore-and-aft direction.

A handle base 29 extending in the vehicle fore-and-aft direction is fixed to an inner face of the outer panel 21. Part of the support arm part 25 in the outer handle 22 protrudes into the outer panel 21, and the extremity of the support arm part 25 is pivotably supported by a front end part, in the vehicle fore-and-aft direction, of the handle base 29. The linking arm part 26 in the outer handle 22 protrudes into the outer panel 21 so as to be inserted into a rear part, in the vehicle fore-and-aft direction, of the handle base 29.

The linking arm part 26 is operatively linked to a latch mechanism (not illustrated) disposed within the vehicle door D. When the latch mechanism is in an unlocked state, by gripping the handle body 24 of the outer handle 22 and operating it in a direction in which it is pulled toward the outer side of the vehicle door D, the latch mechanism releases a closed state of the vehicle door D, thus enabling the vehicle door D to be opened by operation of the handle body 24. Moreover, with regard to the outer handle 22, the linking arm part 26 is urged toward the side on which it is pulled toward the inner side of the vehicle door D by urging means, which is not illustrated.

A cylinder lock 30 (see FIG. 1 and FIG. 2) is fixed to the handle base 29 to the rear of the linking arm part 26 in the vehicle fore-and-aft direction, the cylinder lock 30 switching between a locked state and an unlocked state of the latch mechanism by means of a mechanical key (not illustrated). A base cover 31 made of a synthetic resin is fixed, so as to cover part of the cylinder lock 30, to the outer panel 21 to the rear of the outer handle 22 in the vehicle fore-and-aft direction, the base cover 31 bulging toward the outer side from the outer panel 21 so as to be smoothly connected to the handle body 24 of the outer handle 22 when the outer handle 22 is in a non-operated state. A tact switch 32 for ascertaining the intention of a vehicle user to lock the vehicle door D is disposed on an end part, on the base cover 31 side, within the handle body 24 of the outer handle 22.

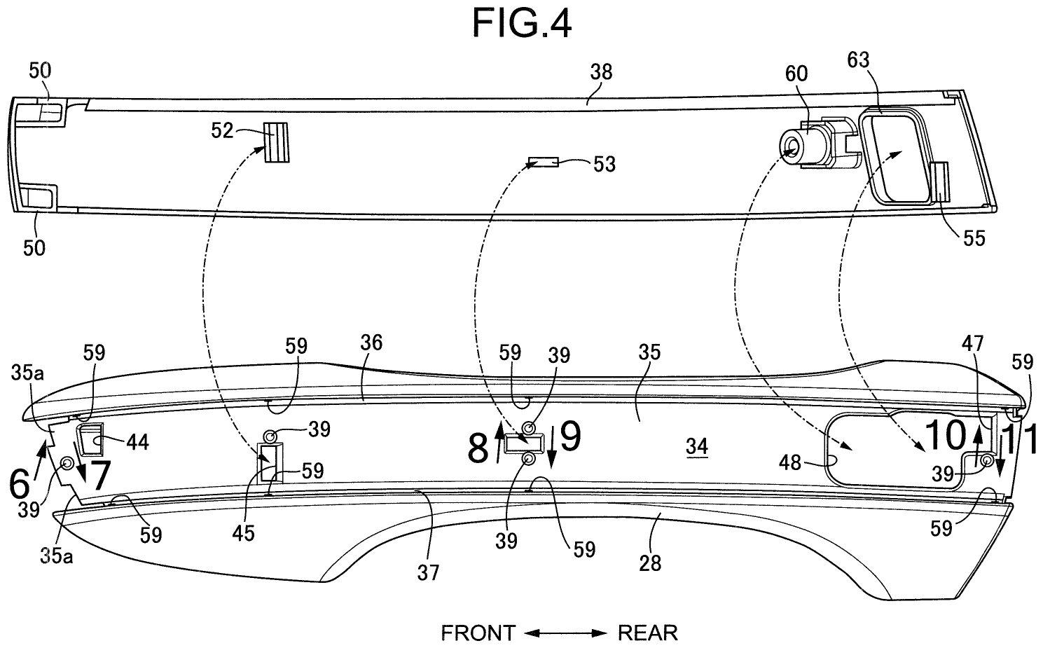

Referring in addition to FIG. 4, a first mounting groove 34, having a substantially U-shaped cross section and formed from a bottom wall 35 that is in an attitude along the upward and downward directions in a state in which the outer handle 22 is attached to the vehicle door D and a pair of side walls 36 and 37 connected to upper and lower ends of the bottom wall 35, is formed in an outside face of the handle body 24 in the vehicle width direction, and in this embodiment the first mounting groove 34 is formed in an outer face, on the outer side in the vehicle width direction, of the handle cover 28 of the handle body 24 along the entire length in the vehicle fore-and-aft direction of the handle cover 28.

A decorative cover 38 is mounted by adhesion on the outside face, in the vehicle width direction, of the handle body 24, that is, on the outer face, on the outer side in the vehicle width direction, of the handle cover 28, the decorative cover 38 being formed from a synthetic resin whose front face has been subjected to plating and being inserted into the first mounting groove 34.

A plurality of, for example five, first supporting projections 39 are projectingly provided on the bottom wall 35 of the first mounting groove 34, the first supporting projections 39 abutting against the decorative cover 38 inserted into the first mounting groove 34, and the decorative cover 38 being adhered to the handle cover 28 in a state in which it is abutted against and supported on the first supporting projections 39.

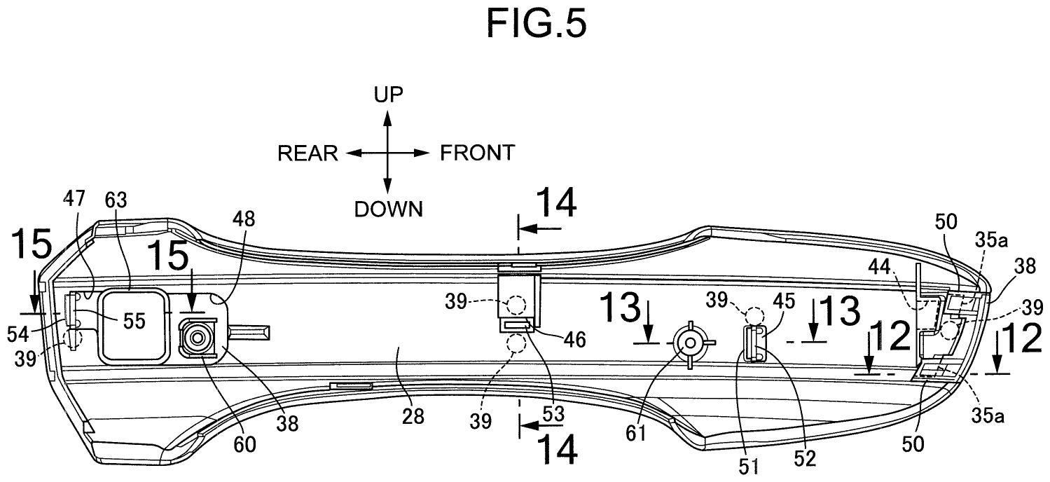

Referring in addition to FIG. 5, a plurality of, for example first to fourth, injection holes 44, 45, 46 and 47 for injecting an adhesive between the decorative cover 38 and the bottom wall 35 for adhering the decorative cover 38 to the handle cover 28 are formed in the bottom wall 35 at a plurality of locations, for example four locations spaced in the longitudinal direction of the first mounting groove 34.

The first supporting projections 39 are projectingly provided on the bottom wall 35, for example, in a circular shape so that at least one thereof is disposed on the periphery of each of the first to fourth injection holes 44 to 47, and in this embodiment one first supporting projection 39 is disposed on the periphery of the first injection hole 44, one first supporting projection 39 is disposed on the periphery of the second injection hole 45, two first supporting projections 39 are disposed on the periphery of the third injection hole 46, and one first supporting projection 39 is disposed on the periphery of the fourth injection hole 47.

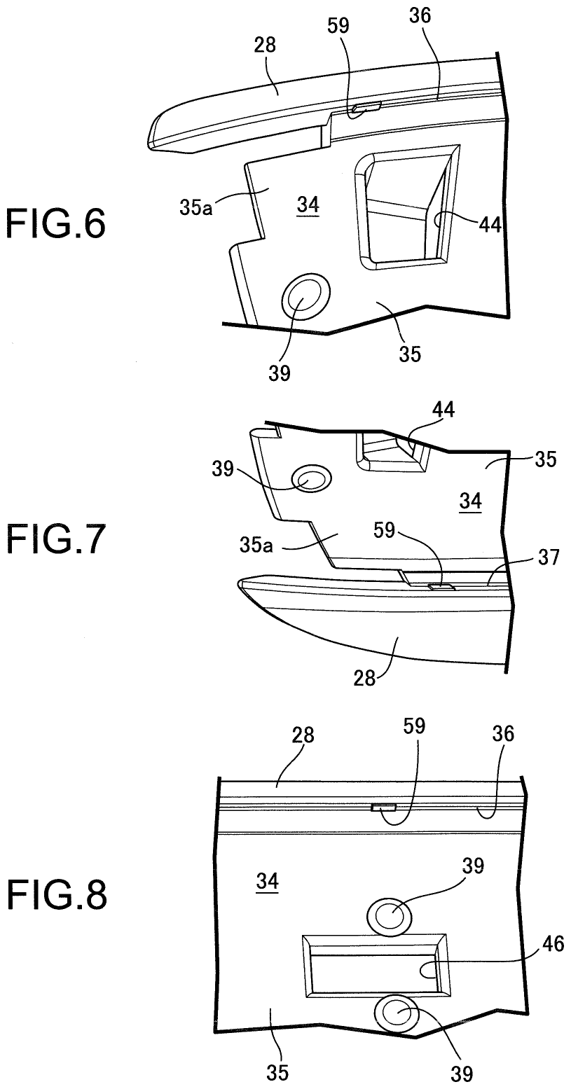

Referring in addition to FIG. 6 and FIG. 7, the first injection hole 44 is formed in a front part of the bottom wall 35 in the vehicle fore-and-aft direction so as to be bent into a substantially L-shaped form and open rearward in the vehicle fore-and-aft direction, and one first supporting projection 39 is disposed downward and to the front on the periphery of the first injection hole 44.

The second injection hole 45 is formed in the bottom wall 35 while having a rectangular shape that is long in the upward and downward directions and is disposed so as to be further to the front in the vehicle fore-and-aft direction than a middle part in the longitudinal direction of the handle cover 28, further to the rear than the first injection hole 44, and close to the side wall 37, and one first supporting projection 39 is disposed on the upper side of the periphery of the second injection hole 45.

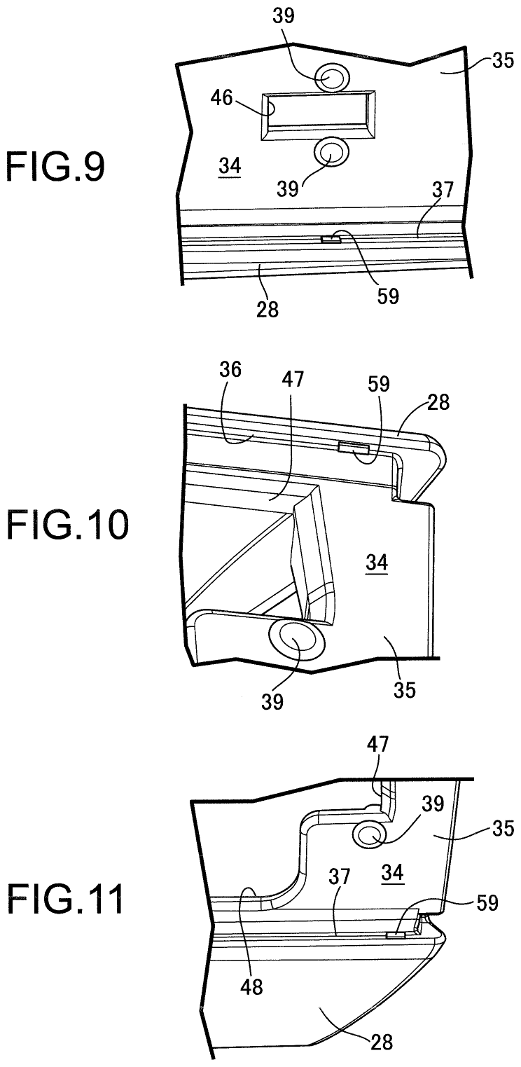

Referring in addition to FIG. 8 and FIG. 9, the third injection hole 46 is formed in the bottom wall 35 while having a rectangular shape that is long in the vehicle fore-and-aft direction and is disposed so as to be in a substantially middle part in the longitudinal direction of the handle cover 28, and first supporting projections 39 are disposed on the upper and lower sides of the periphery of the third injection hole 46.

Referring in addition to FIG. 10 and FIG. 11, formed in a rear part of the bottom wall 35 in the vehicle fore-and-aft direction are an insertion hole 48 having a large rectangular shape extending between the pair of side walls 36 and 37, and the fourth injection hole 47, which is formed so as to have a smaller rectangular shape than that of the insertion hole 48 and so as to be connected to an upper part on the rear side of the insertion hole 48, one first supporting projection 39 being disposed on the lower side of the periphery of the fourth injection hole 47 and to the rear of the insertion hole 48.

The amount of the first supporting projection 39 projecting from the bottom wall 35 is set so that there is no step between an outer face of the decorative cover 38 abutting against the first supporting projection 39 and an outer face on the outer side in the vehicle width direction of the handle cover 28.

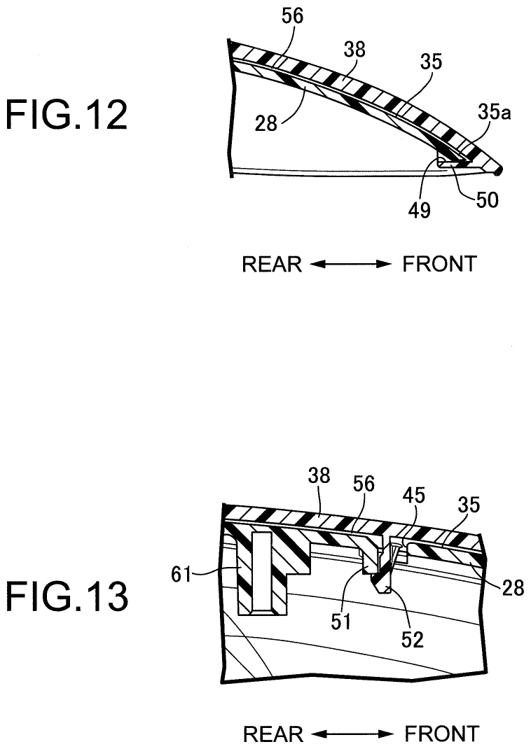

Referring in addition to FIG. 12, a first bent projection 50 bent rearward so as to form a first latching recess 49, opening rearward in the vehicle fore-and-aft direction, between itself and an inner face of a front end part of the decorative cover 38 is provided integrally on each of opposite sides, in the vertical width direction, of the front end part of the decorative cover 38 in the vehicle fore-and-aft direction. On the other hand, a front end insertion portion 35a inserted into and engaging with the first latching recess 49 is formed on each of opposite sides, in the vertical width direction, of the front end part in the vehicle fore-and-aft direction of the bottom wall 35 of the handle cover 28.

Referring in addition to FIG. 13, a first latching projection 51 projecting from the rear edge of the second injection hole 45 toward the handle body main part 27 side is projectingly provided integrally with a face, on the handle body main part 27 side, of the bottom wall 35, and a first engagement claw 52 inserted into the second injection hole 45 and engaging with the first latching projection 45 is projectingly provided integrally with an inner face of the decorative cover 38.

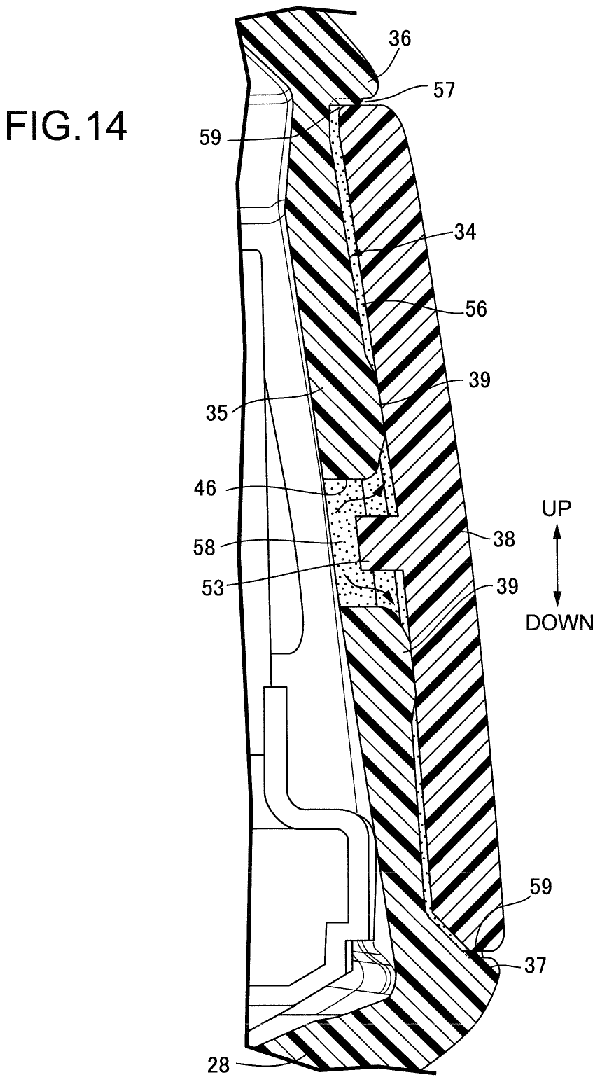

Referring in addition to FIG. 14, an insertion projection 53 inserted into the third injection hole 46 is projectingly provided integrally with the inner face of the decorative cover 38.

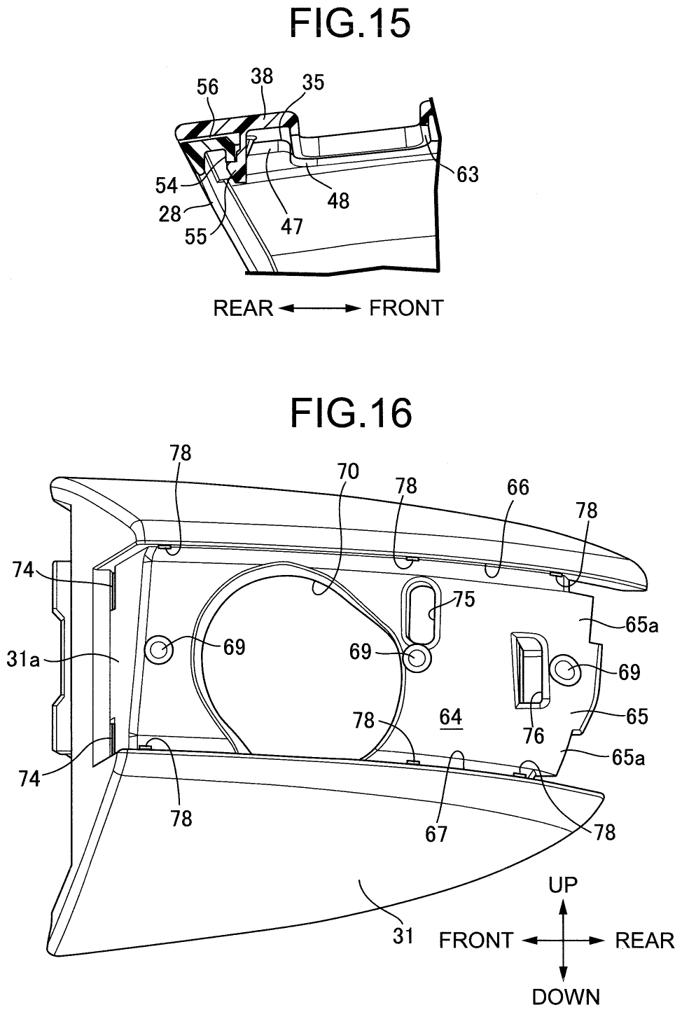

Referring in addition to FIG. 15, a second latching projection 54 projecting from the rear edge of the fourth injection hole 47 toward the handle body main part 27 side is projectingly provided integrally with the face, on the handle body main part 27 side, of the bottom wall 35, and a second engagement claw 55 inserted into the fourth injection hole 47 and engaged with the second latching projection 54 is projectingly provided integrally with the inner face of the decorative cover 38.

When the decorative cover 38 is inserted into the first mounting groove 34 so that the decorative cover 38 is abutted against the plurality of first supporting projections 39 while the front end insertion portion 35a of the bottom wall 35 is inserted into and engaged with the first latching recess 49, the first engagement claw 52 is engaged with the first latching projection 51, the insertion projection 53 is inserted into the third injection hole 46, and the second engagement claw 55 is engaged with the second latching projection 54, a first gap 56 is formed between the bottom wall 35 of the first mounting groove 34 and the decorative cover 38 as shown in FIG. 12 to FIG. 15.

On the other hand, a plurality of, for example four, first positioning projections 59 abutting against the decorative cover 38 so as to form a second gap 57 communicating with the first gap 56 between the pair of side walls 36 and 37 of the first mounting groove 34 and the decorative cover 38 are projectingly provided on each of the side walls 36 and 37 so as to be disposed at positions corresponding to the first to fourth injection holes 44 to 47 in the longitudinal direction of the first mounting groove 34 so as to give a total of eight positioning projections 59.

That is, the first positioning projections 59 individually corresponding to the first to fourth injection holes 44 to 47 in the longitudinal direction of the mounting groove 34 are projectingly provided on the side walls 36 and 37 of the first mounting groove 34, and the amounts via which the first positioning projections 59 project are set so that the gap between the decorative cover 38 and the side walls 36 and 37 of the first mounting groove 34 becomes an appropriate value.

The first and second gaps 56 and 57 are filled with an adhesive 58 (see FIG. 14), the adhesive 58 being injected via the first to fourth injection holes 44 to 47. That is, the adhesive 58 is injected via the first injection hole 44, via a gap formed between the second injection hole 45 and the first engagement claw 52 inserted into the second injection hole 45, via the third injection hole 46, and via a gap formed between the fourth injection hole 47 and the second engagement claw 55 inserted into the fourth injection hole 47; the adhesive 58 thus injected via the third injection hole 46 is guided so as to be separated to opposites sides of the insertion projection 53 as shown by arrows in FIG. 14, guided to the first gap 56, and guided from the first gap 56 to the second gap 57.

As described above, the decorative cover 38 is adhered to the handle cover 28, and in order to fix the handle cover 28 having the decorative cover 38 adhered and fixed thereto to the handle body main part 27, a boss 60 that is to be inserted into the insertion hole 48 is projectingly provided integrally with the decorative cover 38, a boss 61 disposed between the second injection hole 45 and the third injection hole 46 is projectingly provided integrally with the face, on the handle body main part 27 side, of the bottom wall 35 of the handle cover 28, and a screw member (not illustrated) inserted through the handle body main part 27 is screwed into the bosses 60 and 61. In this embodiment, one boss 60 among the two bosses 60 and 61 for fixing the handle cover 28 to the handle body main part 27 is provided on the decorative cover 38 due to the convenience of placement, but it may be provided on the handle cover 28.

The tact switch 32 is fixed to the handle body main part 27 via a part corresponding to the insertion hole 48, and a housing tubular part 63 formed into a rectangular shape so as to house part of the tact switch 32 is projectingly provided integrally with the decorative cover 38 so as to be inserted into the insertion hole 48 to the rear of the boss 60 in the vehicle fore-and-aft direction. The tact switch 32 housed in the housing tubular part 63 is disposed so that part thereof faces the exterior from the decorative cover 38.

Referring in addition to FIG. 16 to FIG. 18, a second mounting groove 64 having a substantially U-shaped cross section formed from a bottom wall 65 in an attitude along the upward and downward directions in a state in which the base cover 31 is attached to the outer panel 21 and a pair of side walls 66 and 67 connected to upper and lower ends of the bottom wall 65 is formed in the outside face of the base cover 31, this second mounting groove 64 being formed in an outer face on the outer side in the vehicle width direction of the base cover 31 along the entire length in the vehicle fore-and-aft direction of the base cover 31. A decorative cover 68 for the base cover formed from a synthetic resin whose surface has been subjected to plating is inserted into the second mounting groove 64, and the decorative cover 68 for the base cover is mounted on the base cover 31 by adhering it thereto.

A plurality of, for example three, second supporting projections 69 abutting against the decorative cover 68 for the base cover inserted into the second mounting groove 64 are projectingly provided on the bottom wall 65 of the second mounting groove 64, and the decorative cover 68 for the base cover is adhered to the base cover 31 in a state in which it is abutted against and supported on the second supporting projections 69.

An opening 70 through which the cylinder lock 30 is inserted is formed in the base cover 31, and a circular window 72 for making a key hole 71 of the cylinder lock 30 face the exterior is formed in the decorative cover 68 for the base cover so as to correspond to the opening 70.

A plurality of, for example fifth to seventh, injection holes 74, 75 and 76 are formed at a plurality of locations, for example three locations, spaced in the vehicle fore-and-aft direction of the base cover 31, the fifth to seventh injection holes 74, 75 and 76 being for injecting an adhesive for adhering the decorative cover 68 for the base cover to the base cover 31 so as to fill between the decorative cover 68 for the base cover and the bottom wall 65.

The fifth injection hole 74 is formed in a front wall 31a at the front end of the base cover 31 in the vehicle fore-and-aft direction, and the fifth injection hole 74, which has a rectangular shape that is long in the upward and downward directions, is formed in the front wall 31a at two locations spaced in the upward and downward directions in a state in which the base cover 31 is mounted on the handle base 29. The sixth injection hole 75 is formed in the bottom wall 65 so as to have a rectangular shape that is long in the upward and downward directions so as to be disposed above the rear side of the opening 70 in the vehicle fore-and-aft direction. The seventh injection hole 76 is formed in a rear part of the bottom wall 65 in the vehicle fore-and-aft direction, and is bent into a substantially L-shaped form so as to open rearward in the vehicle fore-and-aft direction.

The decorative cover 68 for the base cover is formed so as to have, on a front end part of the decorative cover 68 for the base cover, a cover portion 68a covering part of the front wall 31a of the base cover 31, and a pair of third engagement claws 75 inserted into and engaged with the fifth injection holes 74 are projectingly provided on an end part of the cover portion 68a so as to project rearward in the vehicle fore-and-aft direction.

A second bent projection 80 is provided integrally with each of opposite sides in the vertical width direction of a rear end part of the decorative cover 68 for the base cover in the vehicle fore-and-aft direction, the second bent projection 80 being bent forward so as to form a second latching recess 79, opening forward in the vehicle fore-and-aft direction, between itself and an inner face of the rear end part of the decorative cover 68 for the base cover. On the other hand, a rear end insertion portion 65a inserted into and engaged with the second latching recess 79 is formed on each of opposite sides in the vertical width direction in a rear end part in the vehicle fore-and-aft direction of the bottom wall 65 of the base cover 31.

When the decorative cover 68 for the base cover is inserted into the second mounting groove 64 so that the decorative cover 68 for the base cover is abutted against the second supporting projection 69 while the rear end portion 65a of the bottom wall 65 is inserted into and engaged with the second latching recess 79 and the third engagement claw 77 is engaged with the fifth injection hole 74, a third gap 81 is formed between the bottom wall 65 of the second mounting groove 64 and the decorative cover 68 for the base cover as shown in FIG. 18.

An adhesive is injected into the third gap 81 via a gap formed between the fifth injection hole 74 and the third engagement claw 77 engaged with the fifth injection hole 74 and via the sixth injection hole 75 and the seventh injection hole 76, the second supporting projections 69 are projectingly provided on the bottom wall 65 so as to individually correspond to the peripheries of the fifth injection hole 74, the sixth injection hole 76, and the seventh injection hole 77, and the amount of the second supporting projection 69 projecting from the bottom wall 65 is set so that no step is formed between an outer face of the decorative cover 68 for the base cover abutting against the second supporting projections 69 and an outer face on the outer side in vehicle width direction of the base cover 31.

On the other hand, a plurality of, for example three, second positioning projections 78 abutting against the decorative cover 68 for the base cover so as to form a gap (not illustrated) communicating with the third gap 81 between the side walls 66 and 67 of the second mounting groove 64 and the decorative cover 68 for the base cover are projectingly provided on each of the side walls 66 and 67 so as to be disposed at positions corresponding to the fifth to seventh injection holes 74 to 76 in the longitudinal direction of the second mounting groove 64, thus giving a total of six second positioning projections 78. The amounts of these second positioning projections 78 projecting are set so that a gap between the decorative cover 68 for the base cover and the side walls 66 and 67 of the second mounting groove 64 becomes an appropriate value.

Due to such shapes of the base cover 31 and the decorative cover 68 for the base cover, in the same way as in the adhesion and fixing of the decorative cover 38 to the handle cover 28 of the handle body 24, the decorative cover 68 for the base cover is adhered and fixed to the base cover 31.

The operation of this embodiment is now explained. In the outer handle 22 the decorative cover 38 is mounted on the outer face, on the outer side in the vehicle width direction, of the handle body 24 disposed on the outer side of the outer panel 21. The first mounting groove 34, which has a substantially U-shaped cross section and is formed from the bottom wall 35 following the upward and downward directions when the outer handle 22 is attached to the vehicle door D and the pair of side walls 36 and 37 connected to the upper and lower ends of the bottom wall 35, is formed in the outside face of the handle body 24 in the vehicle width direction. The plurality of first supporting projections 39, which abut against the decorative cover 38 inserted into the first mounting groove 34 and form the first gap 56 between the bottom wall 35 and the decorative cover 38, are projectingly provided on the bottom wall 35, the first gap 56 is charged with the adhesive 58, and the decorative cover 38 is therefore fixed to the handle body 24 by use of the adhesive 58; compared with a case in which double-sided tape is used, it is possible to fix the decorative cover 38 to the handle body 24 while cutting the cost and improving the workability.

Moreover, since at least one of the plurality of first supporting projections 39 is disposed on the periphery of each of the first to fourth injection holes 44, 45, 46, and 47 provided in the bottom wall 35 in order to inject the adhesive 58, the adhesive 58 injected into the first gap 56 via the first to fourth injection holes 44 to 47 is reliably charged into the periphery of the first supporting projection 39 within the first gap 56. It becomes possible to reliably fix a part via which the decorative cover 38 is in contact with the handle body 24, said part being the source of an abnormal noise, that is, a part via which the decorative cover 38 is in contact with the first supporting projection 39, while making it unnecessary to inject the adhesive 58 into the entirety of the first gap 56 and suppressing the amount of adhesive 58 used. The occurrence of an abnormal noise can be suppressed by reliably fixing the part via which the decorative cover 38 is in contact with the handle body 24 while suppressing the amount of adhesive 58 used and reducing the cost.

The first mounting groove 34 is formed in the handle body 24 so as to extend lengthwise in the vehicle fore-and-aft direction in a state in which the outer handle 22 is attached to the vehicle door D. The first to fourth injection holes 44 to 47 are formed in the bottom wall 35 at a plurality of locations spaced in the longitudinal direction of the first mounting groove 34. The plurality of first positioning projections 59 abutting against the decorative cover 38 so as to form, between the side walls 36 and 37 and the decorative cover 38, the second gap 57 communicating with the first gap 56 are projectingly provided on the pair of side walls 36 and 37 so as to be disposed at positions corresponding to the first to fourth injection holes 44 to 47 in the longitudinal direction of the first mounting groove 34. It is therefore possible, by making the adhesive 58 flow from the first gap 56 into the second gap 57 formed between the side walls 36 and 37 and the decorative cover 38, to reliably fix a part via which the opposite side parts of the decorative cover 38 are in contact with the handle body 24, that is, a part via which the decorative cover 38 is in contact with the first positioning projection 59 while making it unnecessary to inject the adhesive 58 into the entirety of the second gap 57 and suppressing the amount of adhesive 58 used. The occurrence of an abnormal noise can be suppressed by reliably fixing the part via which the decorative cover 38 is in contact with the handle body 24 while suppressing the amount of adhesive 58 used and reducing the cost.

An embodiment of the present invention is explained above, but the present invention is not limited to the embodiment and may be modified in a variety of ways as long as the modifications do not depart from the subject matter thereof.

1. An outer handle device for a vehicle door in which a handle base is fixed to an outer panel of a vehicle door, an outer handle having a handle body disposed on an outer side of the outer panel is pivotably supported on the handle base, and a decorative cover is mounted on an outer face on the outer side in a vehicle width direction of the handle body, wherein a mounting groove is formed in an outside face of the handle body along the vehicle width direction, the mounting groove having a substantially U-shaped cross section and comprising a bottom wall that follows upward and downward directions in a state in which the outer handle is attached to the vehicle door and a pair of side walls connected to upper and lower ends of the bottom wall, and a plurality of supporting projections, which abut against the decorative cover inserted into the mounting groove and form a first gap between the bottom wall and the decorative cover, are projectingly provided on the bottom wall while being disposed on a periphery of a plurality of injection holes provided in the bottom wall for injecting an adhesive so as to fill the first gap, with at least one of the supporting projections corresponding to one of the injection holes.

2. The outer handle device for a vehicle door according to claim 1, wherein the mounting groove is formed in the handle body so as to extend lengthwise in a vehicle fore-and-aft direction in a state in which the outer handle is attached to the vehicle door, the injection holes are formed in the bottom wall at a plurality of locations spaced in a longitudinal direction of the mounting groove, and a plurality of positioning projections that abut against the decorative cover so as to form, between the side wall and the decorative cover, a second gap communicating with the first gap are projectingly provided on the pair of side walls so as to be disposed at positions corresponding to the injection holes in the longitudinal direction of the mounting groove
